(19) United States
(12) Patent Application Publication
(10) Pub. No.: US 2023/0373626 A1
(43) Pub. Date: Nov. 23, 2023

(54) PACKAGE SUPPORTING DEVICE AND UNMANNED PACKAGE TRANSPORTER

(71) Applicant: TOYOTA JIDOSHA KABUSHIKI KAISHA, Aichi-ken (JP)

(72) Inventor: Hiroaki KIYOKAMI, Nisshin-shi (JP)

(21) Appl. No.: 18/317,101

(22) Filed: May 15, 2023

(30) Foreign Application Priority Data
May 20, 2022 (JP) 2022-083381

(51) Int. Cl. B64D 1/22

(52) U.S. Cl. CPC B64D 1/22

(57) ABSTRACT

A package supporting device includes: a base; leg portions provided at an underside of the base, each of the leg portions including two abutting portions that abut two adjacent side surfaces of a package when viewed from above, and each of the leg portions supporting a corner portion of the package; first supporting portions fixed to the underside of the base, each first supporting portion supporting a respective one of the leg portions so as to be movable toward the package and away from the package; a drive portion that causes each of the leg portions to move toward the package or away from the package; and second supporting portions that are provided between the base and a respective one of the leg portions, and supports the respective one of the leg portions so as to be rotatable with a vertical direction as an axial direction.

### CROSS-REFERENCE TO RELATED APPLICATION

This application is based on and claims priority under 35 USC 119 from Japanese Patent Application No. 2022-083381 filed on May 20, 2022, the disclosure of which is incorporated by reference herein.

### BACKGROUND

### Technical Field

The present disclosure relates to a package supporting device and an unmanned package transporter.

### Related Art

International Publication (WO) No. 2020/194533 discloses a transporting device that supports a container or the like below a small unmanned aerial vehicle and transports the container or the like.

In the transporting device described in International Publication (WO) No. 2020/194533, the size and shape of a container or the like that can be supported below the small unmanned aerial vehicle are fixed, and it is difficult to change the size and shape of the container or the like.

### SUMMARY

In consideration of the above circumstances, an object of the present disclosure is to provide a package supporting device and an unmanned package transporter which are capable of supporting packages of different sizes and shapes.

A package supporting device according to a first aspect includes: a base, a small unmanned aerial vehicle being attached to an upper portion of the base; plural leg portions provided at an underside of the base, each of the leg portions including two abutting portions that abut two adjacent side surfaces of a package when viewed from above, and each of the leg portions supporting a corner portion of the package in a state in which the two abutting portions abut the two adjacent side surfaces of the package; plural first supporting portions fixed to the underside of the base, each first supporting portion supporting a respective one of the leg portions so as to be movable toward the package and away from the package; a drive portion that is operable to cause each of the leg portions to move toward the package or away from the package; and plural second supporting portions, each second supporting portion provided between the base and a respective one of the leg portions and supporting the respective one of the leg portions so as to be rotatable with a vertical direction as an axial direction.

In the package supporting device according to the first aspect, each of the leg portions is supported by a first supporting portion fixed to the base. This enables each of the leg portions to be moved toward the package by operation of the drive portion. When each of the leg portions moves toward the package, each of the leg portions supports a corner portion of the package in a state in which the two abutting portions of each of the leg portions abut two adjacent sides of the package when viewed from above. Further, the package supporting device according to the first aspect includes plural second supporting portions, each second supporting portion supporting a respective one of the leg portions so as to be rotatable with the vertical direction as the axial direction. Accordingly, even if the size and shape of packages as viewed from above are different, each of the leg portions rotates with the vertical direction as the axial direction, enabling the two abutting portions of each of the leg portions to abut two adjacent sides of the package. In this manner, the package supporting device according to the first aspect enables packages having different sizes and shapes to be supported.

A package supporting device according to a second aspect is the package supporting device according to the first aspect and further includes plural rotation restricting portions, each rotation restricting portion restricting rotation of a respective one of the leg portions, with the vertical direction as the axial direction, wherein the plural rotation restricting portions respectively restrict rotation of the leg portions, with the vertical direction as the axial direction, in a state in which each of the leg portions is not supporting the package.

In the package supporting device according to the second aspect, in a state in which each of the leg portions is not supporting package, rotation of the respective leg portions, with the vertical direction as the axial direction, is restricted by the rotation restricting portions. This enables unnecessary rotation of the respective leg portions, with the vertical direction as the axial direction, to be suppressed.

A package supporting device according to a third aspect is the package supporting device according to the second aspect, wherein: each of the rotation restricting portions is a rotation restricting spring, a part of each rotation restricting spring being engaged with a respective one of the leg portions; and rotation of each of the leg portions, with the vertical direction as the axial direction, is allowed by deformation of a respective one of the rotation restricting springs.

In the package supporting device according to the third aspect, rotation of each of the leg portions, with the vertical direction as the axial direction, is allowed by deformation of a respective one of the rotation restricting springs. In this configuration, the leg portions can be returned to their original positions by the restoring force of the deformed rotation restricting springs.

An unmanned package transporter according to a fourth aspect includes: a small unmanned aerial vehicle; a base, the small unmanned aerial vehicle being attached to an upper portion of the base; plural leg portions provided at an underside of the base, each of the leg portions including two abutting portions that abut two adjacent side surfaces of a package when viewed from above, and each of the leg portions supporting a corner portion of the package in a state in which the two abutting portions abut the two adjacent side surfaces of the package; plural first supporting portions fixed to the underside of the base, each first supporting portion supporting a respective one of the leg portions so as to be movable toward the package and away from the package; a drive portion that is operable to cause each of the leg portions to move toward the package or away from the package; and plural second supporting portions, each second supporting portion provided between the base and a respective one of the leg portions and supporting the respective one of the leg portions so as to be rotatable with a vertical direction as an axial direction.

The unmanned package transporter according to the fourth aspect enables a supported package to be transported by a small unmanned aerial vehicle flying. Moreover, in the unmanned package transporter according to the fourth aspect, each of the leg portions is supported by a respective first supporting portion that is fixed to the base. This enables each of the leg portions to be moved toward the package by operation of the drive portion. When each of the leg portions moves toward the package, each of the leg portions supports a corner portion of the package in a state in which the two abutting portions of each of the leg portions abut two adjacent sides of the package when viewed from above. Further, the unmanned package transporter according to the fourth aspect includes plural second supporting portions, each second supporting portion supporting a respective one of the leg portions so as to be rotatable with the vertical direction as the axial direction. Accordingly, even if the size and shape of packages as viewed from above are different, each of the leg portions rotates with the vertical direction as the axial direction, enabling the two abutting portions of each of the leg portions to abut two adjacent sides of the package. In this manner, the unmanned package transporter according to the fourth aspect enables packages having different sizes and shapes to be supported.

The package supporting device and the unmanned package transporter according to the present disclosure have the excellent advantageous effect of being able to support packages of different sizes and shapes.

### BRIEF DESCRIPTION OF THE DRAWINGS

An exemplary embodiment of the present disclosure will be described in detail based on the following figures, wherein:

FIG. 1 is a perspective view illustrating an unmanned package transporter;

FIG. 2 is a perspective view illustrating an unmanned package transporter, and illustrates a state in which a package supporting device is supporting a package;

FIG. 3 is a perspective view illustrating a package supporting device;

FIG. 4 is a plan view of a package supporting device, in which a plate is not illustrated, as viewed from above;

FIG. 5 is a perspective view of a package supporting device, in which a plate is not illustrated, as viewed from above;

FIG. 6 is an enlarged perspective view illustrating the vicinity of a rotation supporting portion in an enlarged manner;

FIG. 7 is a perspective view illustrating a package supporting device and a package, and illustrates a state before respective leg portions support the package;

FIG. 8 is a plan view of a package supporting device and a package, in which a plate is not illustrated, as viewed from above, and illustrates a state before respective leg portions support the package;

FIG. 9 is a perspective view illustrating a package supporting device and a package, and illustrates a state in which respective leg portions are supporting the package;

FIG. 10 is a plan view of a package supporting device and a package, in which a plate is not illustrated, as viewed from above, and illustrates a state in which respective leg portions are supporting the package;

FIG. 11 is a bottom view of a package supporting device and a package, as viewed from below;

FIG. 12 is a bottom view corresponding to FIG. 11, in which a package is not illustrated;

FIG. 13 is an enlarged perspective view illustrating the vicinity of a rotation supporting portion in the state of FIG. 11, in an enlarged manner;

FIG. 14 is a bottom view of a package supporting device and a package, as viewed from below;

FIG. 15 is a bottom view corresponding to FIG. 14, in which a package is not illustrated; and

FIG. 16 is an enlarged perspective view illustrating the vicinity of a rotation supporting portion in the state of FIG. 14, in an enlarged manner.

### DETAILED DESCRIPTION

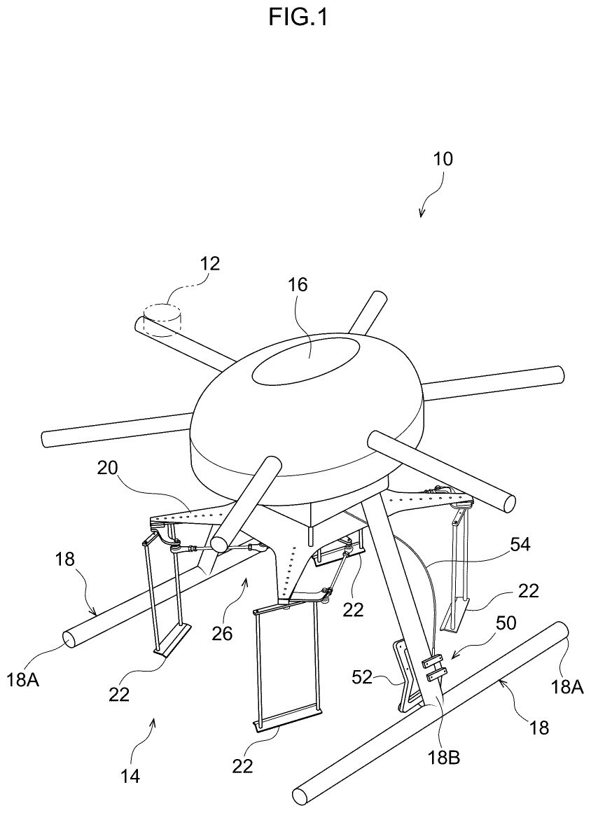

Explanation follows regarding an unmanned package transporter 10 according to an exemplary embodiment of the present disclosure, with reference to FIG. 1 to FIG. 6.

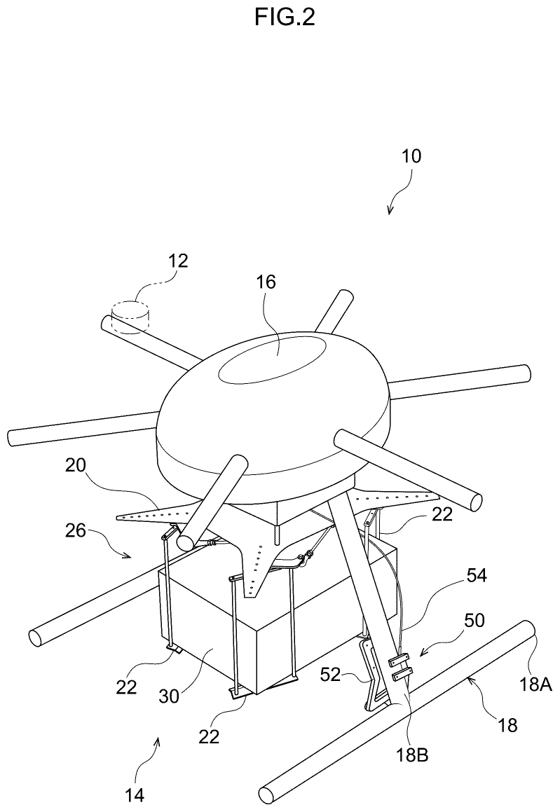

As illustrated in FIG. 1 and FIG. 2, the unmanned package transporter 10 of the present exemplary embodiment includes a small unmanned aerial vehicle 12 and a package supporting device 14 attached to an underside of the small unmanned aerial vehicle 12.

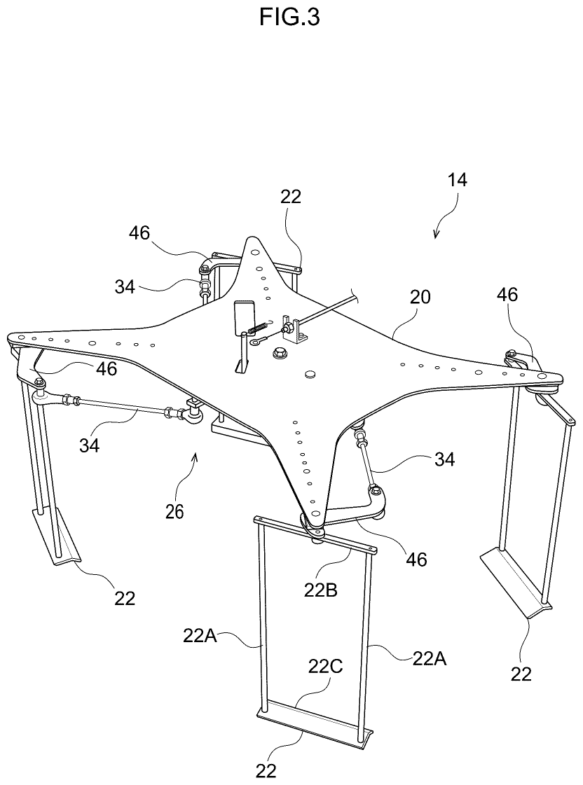

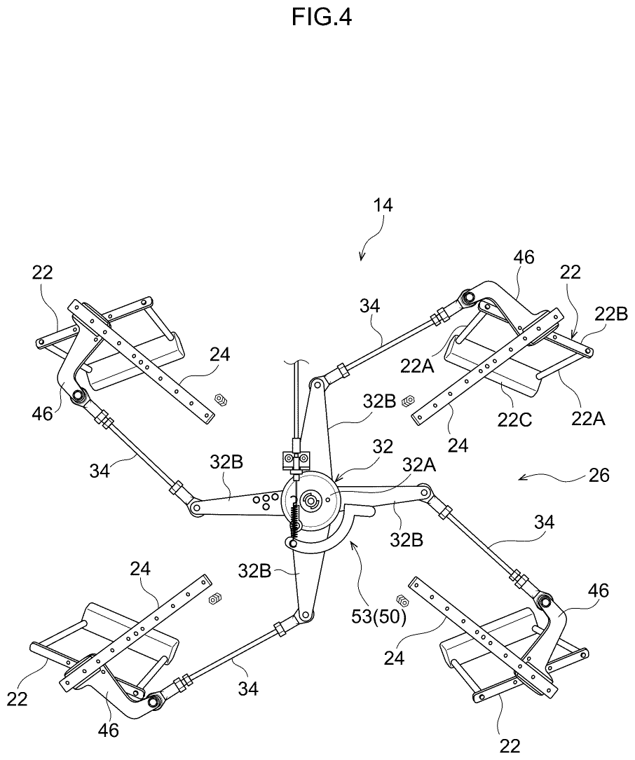

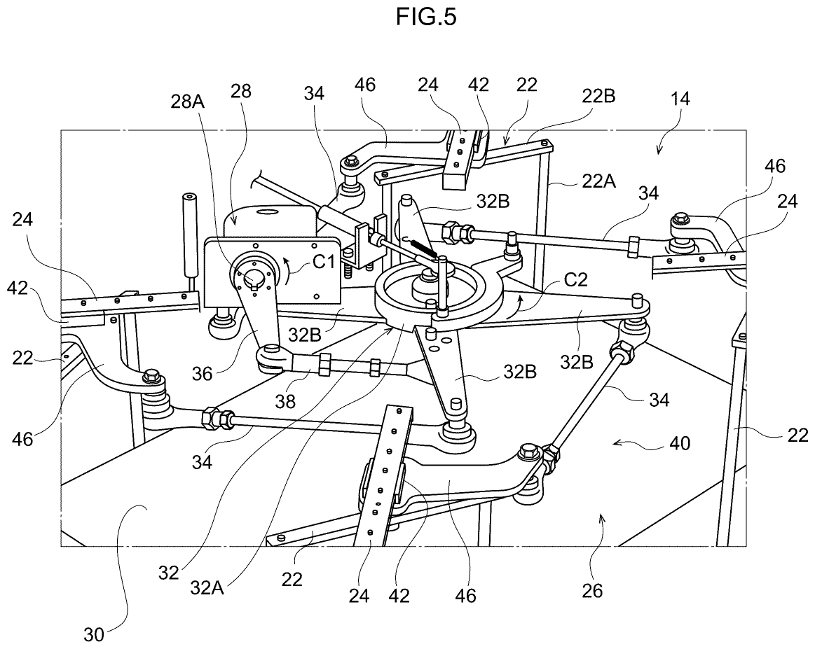

As illustrated in FIG. 1, FIG. 3, FIG. 4, and FIG. 5, the package supporting device 14 includes an aerial vehicle fixing portion 16 to which the small unmanned aerial vehicle 12 is fixed, and a pair of ground contacting portions 18 that contact the ground in a state of having landed. Note that in the present exemplary embodiment, six small unmanned aerial vehicles 12 are fixed to the aerial vehicle fixing portion 16. The pair of ground contacting portions 18 each include a ground contacting portion main body 18A that extends in a horizontal direction and contacts the ground, and a central leg portion 18B that extends upward from a central portion in a longitudinal direction of the ground contacting portion main body 18A. An upper end portion of the central leg portion 18B is connected to a lower portion of the aerial vehicle fixing portion 16.

The package supporting device 14 further includes a plate 20 serving as a base disposed at an underside of the aerial vehicle fixing portion 16 and connected to the aerial vehicle fixing portion 16. In addition, the package supporting device 14 includes four leg portions 22 serving as package supporting portions, four linear guides 24 serving as first supporting portions, a linkage mechanism 26, and an actuator 28.

As illustrated in FIG. 3, the plate 20 is formed in a plate shape with a vertical direction serving as a thickness direction of the plate 20, and has a substantially rectangular shape in which each side of a rectangle is curved inward when viewed from above. The leg portions 22 are respectively attached to the four corners of the plate 20.

Each of the leg portions 22 includes two abutting portions 22A with space therebetween in the horizontal direction, which is a direction orthogonal to the vertical direction, an upper connecting portion 22B connecting upper ends of the two abutting portions 22A in the horizontal direction, and a lower connecting portion 22C connecting lower ends of the two abutting portions 22A in the horizontal direction. The two abutting portions 22A are formed in a round bar shape with an axial direction thereof extending in the vertical direction. Further, the upper connecting portion 22B is formed in a plate shape extending horizontally with the vertical direction serving as a thickness direction of the upper connecting portion 22B. An upper end portion of one abutting portion 22A is fixed to one end portion of the upper connecting portion 22B, and an upper end portion of the other abutting portion 22A is fixed to the other end portion of the upper connecting portion 22B. The lower connecting portion 22C is formed in a plate shape extending in the horizontal direction with the vertical direction serving as a thickness direction of the lower connecting portion 22C. A lower end portion of one abutting portion 22A is fixed to one end portion of the lower connecting portion 22C, and a lower end portion of the other abutting portion 22A is fixed to the other end portion of the lower connecting portion 22C. As illustrated in FIG. 2, the lower connecting portion 22C is a portion that supports the package 30 from below. Further, the two abutting portions 22A are portions that support the package 30 from the sides. Note that the four leg portions 22 are configured similarly to each other.

As illustrated in FIG. 3 and FIG. 4, each linear guide 24 is formed in a plate shape extending in the horizontal direction with the vertical direction serving as a thickness direction of the linear guide 24. The shape of each linear guide 24 when viewed from above is a rectangular shape. Further, the four linear guides 24 are fixed to the plate 20 in a state in which each of the linear guides is disposed at an underside of a respective one of the four corners of the plate 20. Viewing the four linear guides 24 from above, one side of each of the four linear guides 24 in the longitudinal direction is directed toward the center of the plate 20 (the center of the drawings). Each of the four leg portions 22 is supported by a respective one of the four linear guides 24 via a slide portion 42, a rotation supporting portion 44, and the like, which are described below. Each of the leg portions 22 is movable from the corner to the center of the plate 20 along a respective one of the linear guides 24, and is also movable from the center to the corner of the plate 20.

The link mechanism 26 includes a central link 32 disposed at an underside of a central portion of the plate 20 as viewed from above, and four outer links 34 are respectively connected to the central link 32. As illustrated in FIG. 4 and FIG. 5, the central link 32 includes a rotating portion 32A that is rotatably supported by the plate 20 with the vertical direction as an axial direction, and four protruding arm portions 32B that protrude from the rotating portion 32A toward the outside of the rotating portion 32A in a radial direction of rotation. The four protruding arm portions 32B are arranged with spaces therebetween in a circumferential direction of rotation of the rotating portion 32A. An end of each of the four protruding arm portions 32B opposite to the rotating portion 32A is connected to one end of a respective one of the four outer links 34 via a ball joint. The other end of each of the four outer links 34 is connected to a respective one of four slide brackets 46, which are described below, via a ball joint.

As illustrated in FIG. 5, the actuator 28 is, for example, a motor actuator that rotates an output shaft 28A. The actuator 28 is fixed to the plate 20 in a state in which the actuator 28 is disposed on the plate 20 (see FIG. 3). A first rod 36 is fixed to the output shaft 28A of the actuator 28. The first rod 36 is inserted through an opening that is formed in the plate 20. As a result, an end portion of the first rod 36 opposite to the output shaft 28A is situated below the plate 20. One end of a second rod 38 is connected to the end of the first rod 36 opposite to the output shaft 28A via a ball joint. Moreover, the other end of the second rod 38 is connected to one of the protruding arm portions 32B of the central link 32 via a ball joint. This connects the output shaft 28A of the actuator 28 and the central link 32 together via the first rod 36 and the second rod 38. As a result, the central link 32 rotates in conjunction with the rotation of the output shaft 28A of the actuator 28. The actuator 28, the first rod 36, the second rod 38, the central link 32, and the four outer links 34 configure a drive portion 40 that moves each of the leg portions 22 toward the package 30 or away from the package 30.

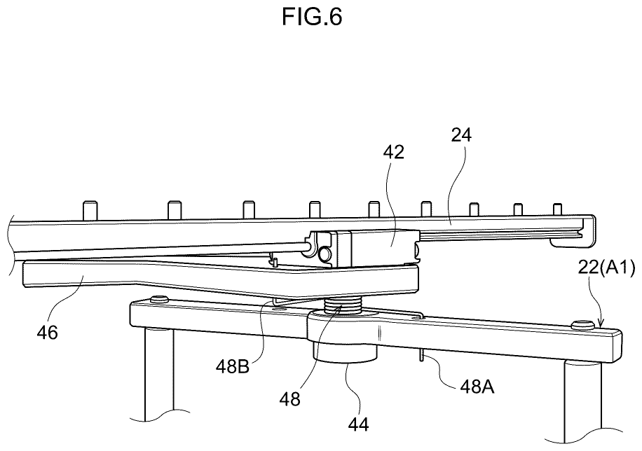

As described above, each of the leg portions 22 is supported by a respective one of the linear guides 24 via a slide portion 42, a rotation supporting portion 44, and the like. More specifically, as illustrated in FIG. 6, each of the leg portions 22 is supported by a respective one of the linear guides 24 via a slide portion 42, a slide bracket 46, and a rotation supporting portion 44. The slide portion 42 is engaged with the linear guide 24. The slide portion 42 is configured to slide (move) along the longitudinal direction of the linear guide 24. Further, the slide bracket 46 is fixed to a lower portion of the slide portion 42. As illustrated in FIG. 5, the other end of the outer link 34 is connected via a ball joint to an end of the slide bracket 46 opposite to the slide portion 42. The rotation supporting portion 44, serving as a second supporting portion, protrudes downward from a lower portion of the slide bracket 46. The rotation supporting portion 44 engages with a central portion in a longitudinal direction of the upper connecting portion 22B of the leg portion 22, such that the leg portion 22 is rotatably supported by the rotation supporting portion 44 with the vertical direction as an axial direction.

A rotation restricting spring 48, serving as a rotation restricting portion, is provided between the upper connecting portion 22B of each of the leg portions 22 and a respective one of the slide brackets 46. The rotation restricting spring 48 is, for example, a torsion spring. The rotation supporting portion 44 is inserted through the rotation restricting spring 48. Further, one end 48A of the rotation restricting spring 48 is engaged with a hole formed in the upper connecting portion 22B. The other end 48B of the rotation restricting spring 48 is engaged with a hole formed in the slide bracket 46. The rotation restricting spring 48 is deformed so as to allow rotation of the leg portion 22 with the vertical direction as an axial direction.

### Operation and Effects of the Present Exemplary Embodiment

Next, explanation follows regarding operation and effects of the present exemplary embodiment.

As illustrated in FIG. 1 and FIG. 2, in the unmanned package transporter 10 of the present exemplary embodiment, the package supporting device 14 can support the package 30 in a state in which the ground contacting portions 18 are in contact with the ground (a state in which the unmanned package transporter 10 has landed).

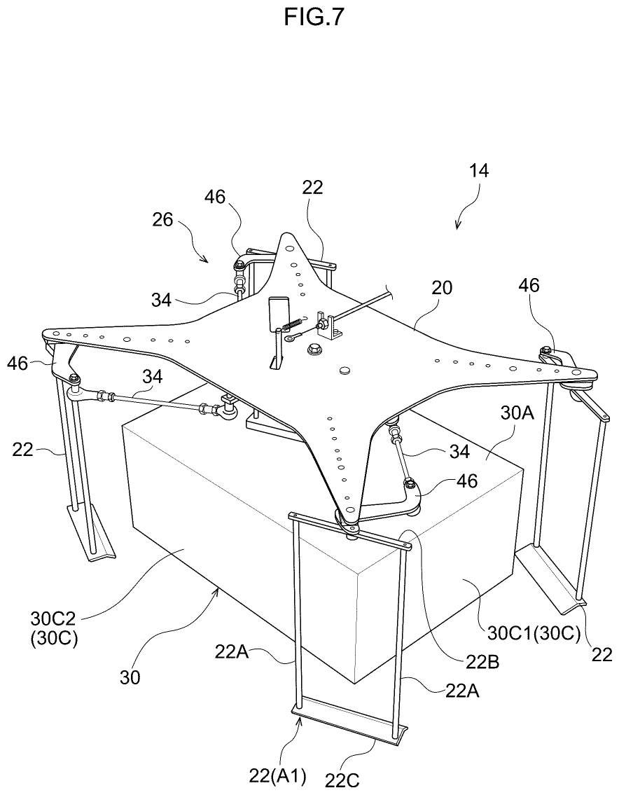

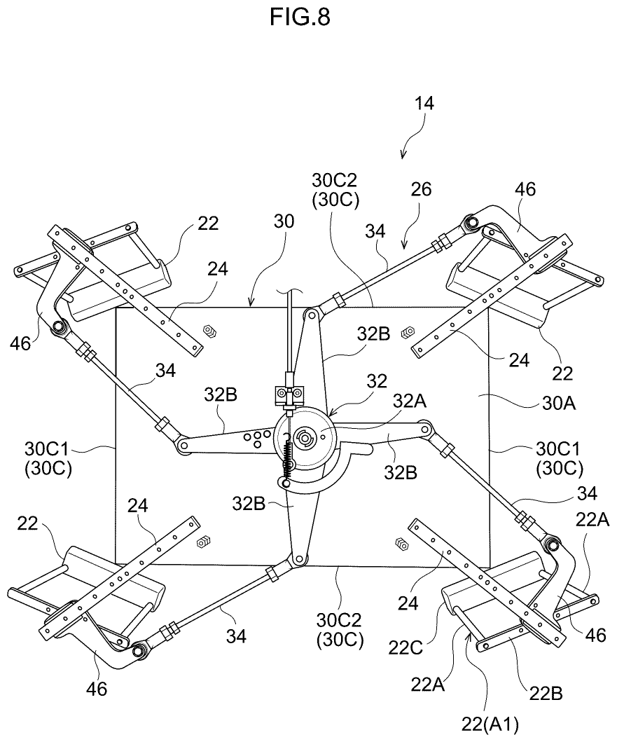

More specifically, in the state illustrated in FIG. 7 and FIG. 8, a rectangular parallelepiped package 30 is disposed below the plate 20, and the respective leg portions 22 are not contacting the package 30. In this state, each of the leg portions 22 is maintained in an orientation determined by a respective one of the rotation restricting springs 48 (see FIG. 6). This enables unnecessary rotation of the respective leg portions 22, with the vertical direction as an axial direction, to be restricted in a state in which the respective leg portions 22 do not support the package 30. Note that the orientation of each leg portion 22 in relation to a respective one of the linear guides 24 in a state in which the respective leg portions 22 do not support the package 30 is referred to as a standard orientation A1.

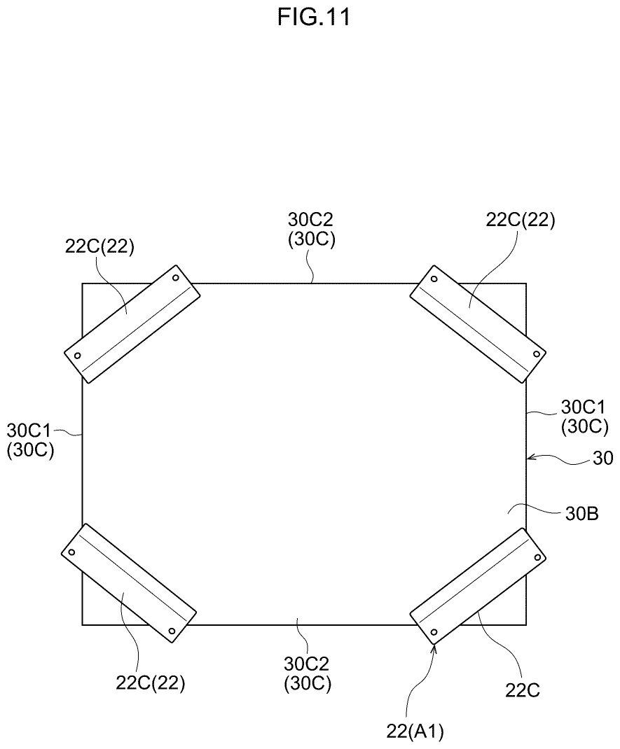

Note that the package 30 includes a rectangular upper surface 30A and a rectangular lower surface 30B (see FIG. 11), and four side surfaces 30C connecting the upper surface 30A and the lower surface 30B in the vertical direction. Among the four side surfaces 30C, two side surfaces 30C having a smaller dimension in the horizontal direction are referred to as first side surfaces 30C1, and among the four side surfaces 30C, two side surfaces 30C having a dimension in the horizontal direction that is larger than the dimension in the horizontal direction of the first side surfaces 30C1 are referred to as second side surfaces 30C2. Note that the package 30 illustrated in FIG. 7 to FIG. 11 is a package with a standard aspect ratio set at a predetermined aspect ratio by a ratio (hereafter referred to as an “aspect ratio”) of a dimension in a horizontal direction of the first side faces 30C1 to a dimension in a horizontal direction of the second side faces 30C2.

As illustrated in FIG. 5, when the output shaft 28A of the actuator 28 rotates to one side (in the direction of the arrow C1), and the central link 32 rotates to one side (in the direction of the arrow C2), the four outer links 34 pull the four slide brackets 46. This causes the respective leg portions 22 to move toward the package 30. Note that an operating state of the drive portion 40, which is caused by rotation of the output shaft 28A of the actuator 28 to one side (in the direction of the arrow C1), is referred to as a first state (an operating state when a package is supported).

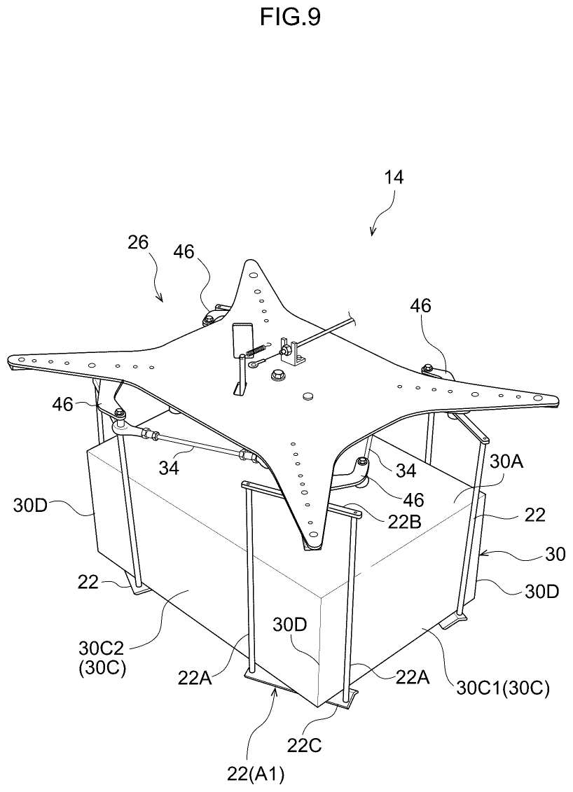

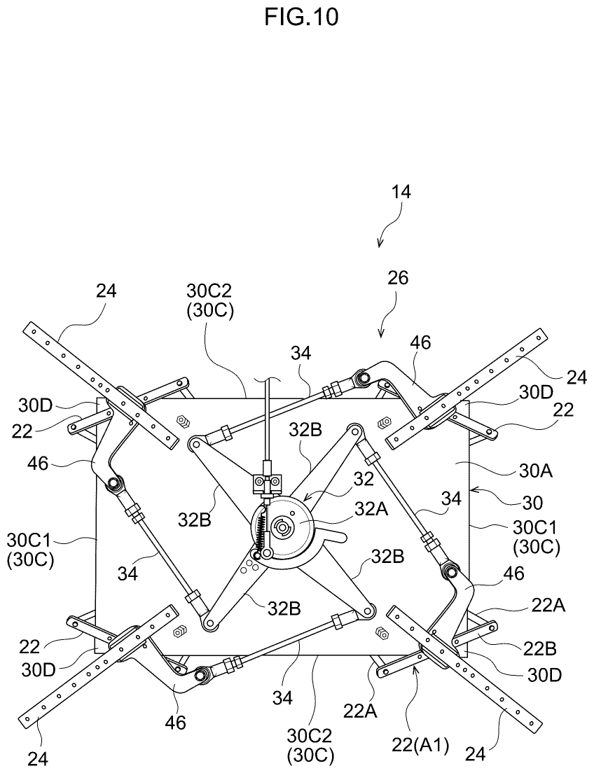

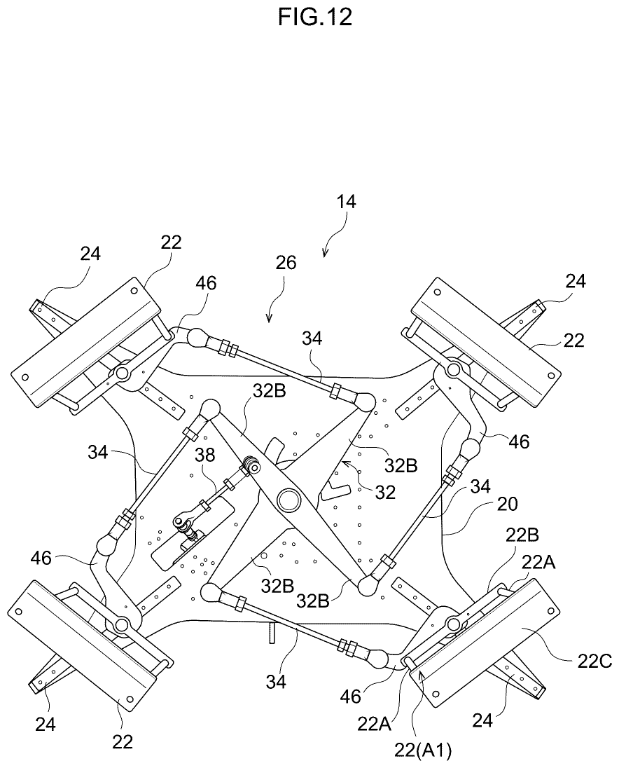

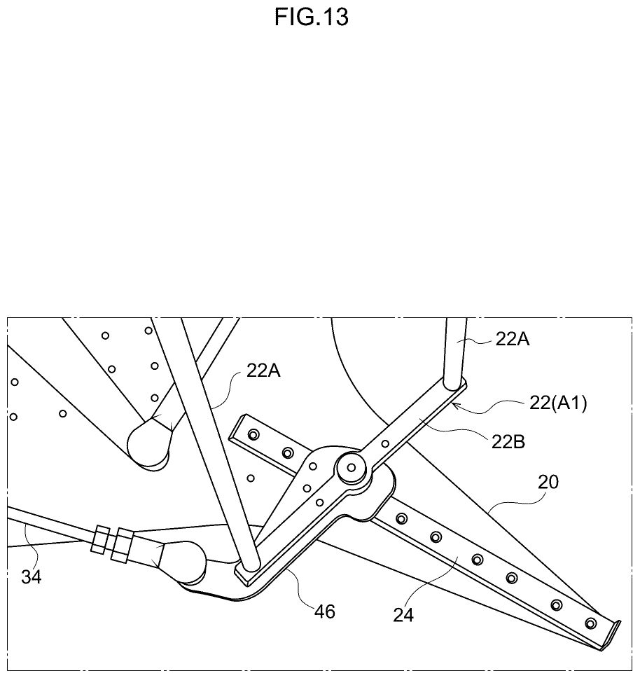

As illustrated in FIG. 9 and FIG. 10, when each of the leg portions 22 moves toward the package 30, the two abutting portions 22A of each of the leg portions 22 abut the adjacent first side surface 30C1 and second side surface 30C2, respectively. As illustrated in FIG. 10, FIG. 11, FIG. 12, and FIG. 13, in a case in which the package 30 has a standard aspect ratio, the respective leg portions 22 are substantially prevented from rotating from the standard orientation A1. Namely, in the present exemplary embodiment, the standard orientation A1 of each of the leg portions 22 is set in accordance with the package 30 having a standard aspect ratio. Note that the package 30 is not illustrated in FIG. 12 and FIG. 13.

As illustrated in FIG. 9, FIG. 11, and FIG. 12, when the two abutting portions 22A of each of the leg portions 22 abut the adjacent first side surface 30C1 and second side surface 30C2, respectively, the lower connecting portion 22C of each leg portion 22 is disposed along the lower surface 30B of the package 30. This enables the four corner portions 30D of the package 30 to be supported by the respective leg portions 22.

As illustrated in FIG. 2, when each small unmanned aerial vehicle 12 is activated, each small unmanned aerial vehicle 12 flies together with the package supporting device 14. This enables the package 30, which is supported by the package supporting device 14, to be transported by air.

Note that in a state in which the unmanned package transporter 10 has landed, as illustrated in FIG. 5, when the output shaft 28A of the actuator 28 is rotated to the other side (the side opposite to the direction of the arrow C1) and the central link 32 is rotated to the other side (the side opposite to the direction of the arrow C2), the four outer links 34 push the four slide brackets 46. This causes each of the leg portions 22 to move away from the package 30. As a result, the package 30, which is supported by the respective leg portions 22, can be unloaded from the package supporting device 14. Note that an operating state of the drive portion 40, which is caused by rotation of the output shaft 28A of the actuator 28 to the other side (the side opposite to the direction of the arrow C1), is referred to as a second state (an operating state when a package is unloaded).

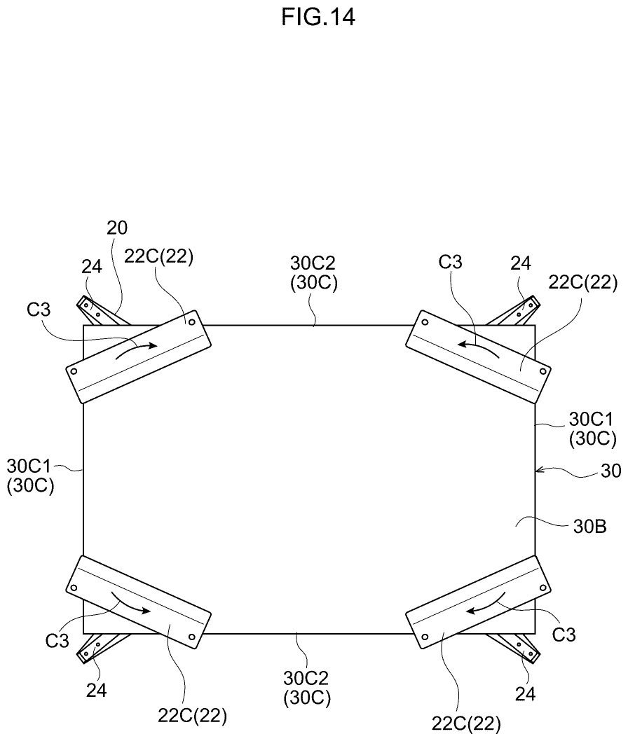

FIG. 14 shows a package 30 with a flat aspect ratio in which the dimension in the horizontal direction of the first side surfaces 30C1 is smaller than the dimension in the horizontal direction of the first side surfaces 30C1 of the package 30 with a standard aspect ratio. Explanation follows regarding movement of the respective leg portions 22 when the respective leg portions 22 support a package 30 with a flat aspect ratio.

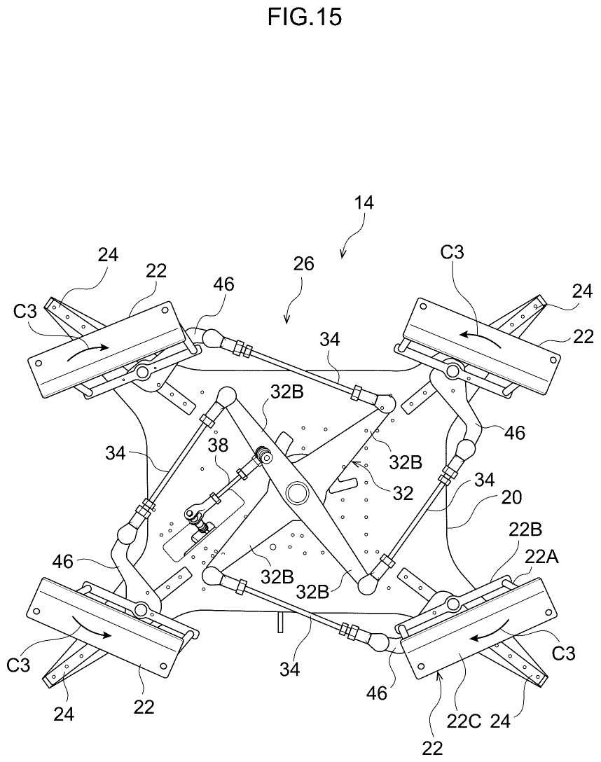

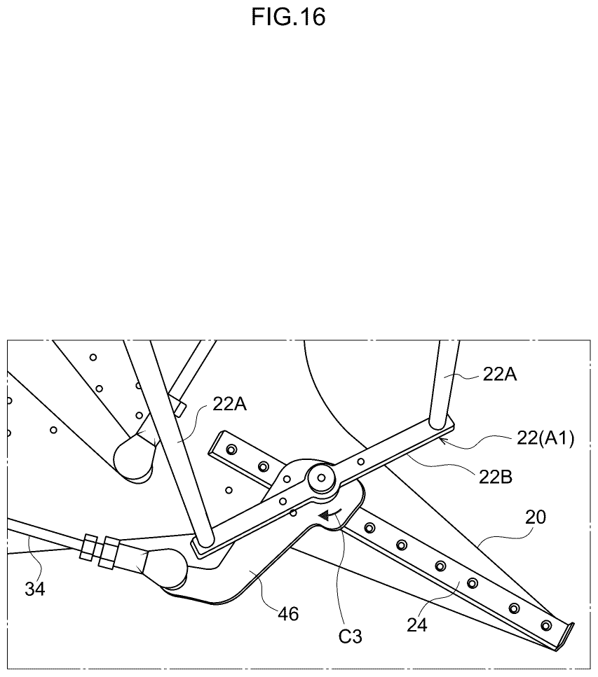

As illustrated in FIG. 14, FIG. 15, and FIG. 16, when each of the leg portions 22 moves toward the package 30, first, one abutting portion 22A of each of the leg portions 22 abuts the first side surface 30C1. In a state in which one abutting portion 22A of each of the leg portions 22 is abutting the first side surface 30C1, further movement of the respective leg portions 22 toward the package 30 causes the respective leg portions 22 to rotate from the standard orientation A1 to one side (in the direction of the arrow C3). Note that when the respective leg portions 22 rotate from the standard orientation A1 to one side, the rotation restricting springs 48 (see FIG. 6) deform. When each of the leg portions 22 rotates from the standard orientation A1 to one side, the other abutting portion 22A of each of the leg portions 22 abuts the second side surface 30C2. When the two abutting portions 22A of the each of the leg portions 22 abut the first side surface 30C1 and the second side surface 30C2 which are adjacent to each other, the lower connecting portion 22C of each of the leg portions 22 is disposed along the lower surface 30B of the package 30 with a flat aspect ratio. This enables the four corner portions 30D of the package 30 with a flat aspect ratio to be supported by the respective leg portions 22.

As described above, the package supporting device 14 of the unmanned package transporter 10 of the present exemplary embodiment can support a package 30 of different sizes and shapes (aspect ratios).

In a state in which the four corner portions 30D of the package 30 with a flat aspect ratio are supported by the respective leg portions 22, when the respective leg portions 22 move away from the package 30 with a flat aspect ratio, the package 30 with a flat aspect ratio, which is supported by the respective leg portions 22, is unloaded from the package supporting device 14. At this time, the respective leg portions 22 are returned to the standard orientation A1 by the restoring force (biasing force) of the rotation restricting springs 48. In this manner, in the present exemplary embodiment, when the respective leg portions 22 are not contacting the package 30, the respective leg portions 22 can be returned to the standard orientation A1.

Note that although an example in which unnecessary rotation of the respective leg portions 22 is suppressed using the rotation restricting springs 48 has been described in the present exemplary embodiment, the present disclosure is not limited thereto. For example, providing a rotation restricting portion that causes friction between the upper connecting portion 22B of each of the leg portions 22 and an a respective one of the slide brackets 46 may suppress unnecessary rotation of the respective leg portions 22.

Although explanation has been given regarding an exemplary embodiment of the present disclosure, the present disclosure is not limited to the above description, and obviously various other modifications may be implemented within a range that does not depart from the gist of the present disclosure.

What is claimed is:

1. A package supporting device comprising:
a base, an upper portion of the base being configured to be attached to an unmanned aerial vehicle;
a plurality of leg portions provided at an underside of the base, each of the leg portions including two abutting portions that abut two adjacent side surfaces of a package when viewed from above, and each of the leg portions supporting a corner portion of the package in a state in which the two abutting portions abut the two adjacent side surfaces of the package;
a plurality of first supporting portions fixed to the underside of the base, each first supporting portion supporting a respective one of the leg portions so as to be movable toward the package and away from the package;
a drive portion that is operable to cause each of the leg portions to move toward the package or away from the package; and
a plurality of second supporting portions, each second supporting portion being provided between the base and a respective one of the leg portions, and supporting the respective one of the leg portions so as to be rotatable with a vertical direction as an axial direction.

2. The package supporting device according to claim 1, further comprising a plurality of rotation restricting portions, each rotation restricting portion restricting rotation of a respective one of the leg portions, with the vertical direction as the axial direction, wherein the plurality of rotation restricting portions respectively restrict rotation of the leg portions, with the vertical direction as the axial direction, in a state in which each of the leg portions is not supporting the package.

3. The package supporting device according to claim 2, wherein:
each of the rotation restricting portions is a rotation restricting spring, a part of each rotation restricting spring being engaged with a respective one of the leg portions; and
rotation of each of the leg portions, with the vertical direction as the axial direction, is allowed by deformation of a respective one of the rotation restricting springs.

4. An unmanned package transporter comprising:
an unmanned aerial vehicle;
a base, the unmanned aerial vehicle being attached to an upper portion of the base;
a plurality of leg portions provided at an underside of the base, each of the leg portions including two abutting portions that abut two adjacent side surfaces of a package when viewed from above, and each of the leg portions supporting a corner portion of the package in a state in which the two abutting portions abut the two adjacent side surfaces of the package;
a plurality of first supporting portions fixed to the underside of the base, each first supporting portion supporting a respective one of the leg portions so as to be movable toward the package and away from the package;
a drive portion that is operable to cause each of the leg portions to move toward the package or away from the package; and
a plurality of second supporting portions, each second supporting portion being provided between the base and a respective one of the leg portions, and supporting the respective one of the leg portions so as to be rotatable with a vertical direction as an axial direction.
